(19) United States
(12) Patent Application Publication
(10) Pub. No.: US 2011/0136023 A1
(43) Pub. Date: Jun. 9, 2011

(54) INTEGRATED HYDRIDE AIR ACCUMULATOR SYSTEM AND METHOD FOR MANUFACTURING THE SAME

(76) Inventors: Christian Bretthauer, Freiburg (DE); Holger Reinecke, Emmendingen (DE); Class Mueller, Freiburg (DE)

(21) Appl. No.: 12/997,603

(22) PCT Filed: Jun. 18, 2009
(86) PCT No.: PCT/EP09/04401

§ 371 Date: Feb. 11, 2011

(30) Foreign Application Priority Data
Jun. 18, 2008 (DE) 10 2008 028 649.4

(51) Int. Cl. H01M 12/06; H01M 12/00

(52) U.S. Cl. 429/404; 429/535

(57) ABSTRACT

The present invention relates to an integrated hydride air accumulator system and method for manufacturing the same. More specifically, the present invention relates to an integrated hydride/air accumulator with an air electrode, a hydride storage and a counter electrode conductively connected with the hydride storage which is in electrical contact with an electrolyte and an ionically conductive membrane between the air electrode and the counter electrode.

### CROSS REFERENCE TO RELATED APPLICATIONS

This application relates to and claims priority from PCT/EP2009/004401 filed Jun. 18, 2009, the entire contents of which are incorporated herein by reference, which in turn claims priority from DE 10 2008 028 649.4 filed Jun. 18, 2008.

### FIGURE SELECTED FOR PUBLICATION

FIG. 1

### BACKGROUND OF THE INVENTION

1. Field of the Invention

The present invention relates to an integrated hydride air accumulator system and method for manufacturing the same. More specifically, the present invention relates to an integrated hydride/air accumulator with an air electrode, a hydride storage and a counter electrode conductively connected with the hydride storage which is in electrical contact with an electrolyte and an ionically conductive membrane between the air electrode and the counter electrode.

2. Description of the Related Art

The related art involves the microsystems designed today which still continue to rely on macroscopic energy sources, such as external power supplies or batteries. As a result, in many cases this significantly limits the integration density and functionality.

One approach of solving these problems lies in the integration of different micro generators on the chip level where the objective is to create an autonomous microsystem which can supply itself with sufficient electrical energy through the conversion of ambient forms of energy. Unfortunately, such autonomous microsystems always require an energy storage device in spite of the integrated microgenerator because the ambient energy provided for conversion can be subject to significant fluctuations. These fluctuations can create energy bottlenecks that can be absorbed by a suitable energy storage device. With a microsystem supplied by solar energy, for instance, an energy storage device must be provided that during the day is charged with sufficient excess energy so that during the night the microsystem can be solely supplied by the stored energy. Previous attempts solve this problem of energy storage with integrated lithium accumulators have proven unsatisfactory as requiring costly manufacturing methods under a protective atmosphere and which achieve only very small storage capacities.

A further problem is that the small storage capacity of lithium accumulators is due to the large volume expansion of lithium layers during the charging process, as a result of which such type of production is only possible using thin lithium layers in the range of a few micrometers. As a result of only thin lithium layers, only small storage capacities within the range of approximately 1 mWh/cm2 can be achieved as well. An additional disadvantage of the integrated lithium accumulators is an expensive encapsulation that is necessary because of the high lithium reactivity.

In U.S. Pat. No. 7,166,384 B2, an integratable accumulator for integrated systems was disclosed, for example, which serves to supply the energy to MEMS (micro-electro-mechanical-systems). The accumulators disclosed there have nickel and metal hydride electrodes, for example, which are arranged spaced apart in an electrolyte and are encapsulated by a polymer layer. The integrated accumulators are mounted on a silicon substrate which is insulated with a silicon dioxide layer. Polyimide spacers are arranged on a first electrode, which limit the cavity for the electrolyte and serve as a support surface for the second electrodes. As already described above, the complete arrangement is encapsulated by a polymer layer which provides a further detriment to effective manufacture and utilization.

A paper “A Photorechargeable Metal Hybride/Air Battery” by Keiji Akuto and Yoji Sakurai that was published in the Journal of the Electrochemical Society, 148 (2), pp A121 to A125 in 2001, describes a macroscopic self-charging metal hydride/air accumulator which consists of a platinum cathode as well as a semiconductor coated metal hydride anode in an electrolyte of concentrated potassium hydroxide solution. With the design described there it was possible to achieve a photocatalytic self-charge of the accumulator, as a result of which it is possible to develop a largely autonomous system.

The previously known energy storage devices, e.g. high-performance capacitors, such as gold-cap or electrolyte capacitors, have the disadvantage that when compared to accumulators, they can only attain a very small volumetric energy density in the range of 1 mWh/cm3 and they have very high leakage currents in the range of some 10 to 100 μA. Compared to the integrated microsystems and electrical circuits, they also have a very large physical size of several cm3 and are difficult to produce as an integrated design.

External macroscopic accumulators, such as known from the paper by Akuto and Sakurai, also have the disadvantage that they have a relatively large physical size in the range of cm3 compared to microsystems and electrical circuits and, compared to thin-film accumulators, also have a relatively low volumetric energy density of approximately 400 mWh/cm3.

Another disadvantage of the systems known from the state of the art is also the high complexity for processing the described arrangements as well as the use of concentrated alkali solutions as an electrolyte. The previously described self-charging systems moreover have the problem that carbonate is formed on the air electrode which significantly reduces the stability and the durability of the accumulator cell.

### OBJECTS AND SUMMARY OF THE INVENTION

An object of the present invention is to provide an integrated hydride/air accumulator to the extent that increased stability and energy density can be achieved, that the accumulator can be integrated in a normal CMOS semiconductor process in a front or backend process, while at the same time ensuring a manufacturing process that is as simple as possible.

The present invention relates to an integrated hydride air accumulator system and method for manufacturing the same. More specifically, the present invention relates to an integrated hydride/air accumulator with an air electrode, a hydride storage and a counter electrode conductively connected with the hydride storage which is in electrical contact with an electrolyte and an ionically conductive membrane between the air electrode and the counter electrode.

According to an embodiment of the present invention the concerns noted are solved by the provided system and method.

According to another embodiment of the present invention, there is provided an integrated hydride air accumulator system, comprising: an air electrode; a hydride storage device; a counter electrode; an ionically conductive membrane arranged between the air electrode and the counter electrode, the counter electrode conductively coupled with the hydride storage device, and the hydride storage device being in operative contact with an electrolyte.

According to another embodiment of the present invention, there is provided a method for the production of an integrated hydride air accumulator system, comprising the steps of: providing a substrate, creating a diffusion barrier on the substrate, providing an air electrode, attaching and structuring an air electrode on one top side of the substrate, creating a cavity on a rear side of the substrate up to the air electrode, performing at least one of a step of attaching and creating an ionically conductive membrane on a rear side of the air electrode, precipitation of a hydride storage device on a rear side of the membrane, performing at least one of a step of attaching and creating a counter electrode on the rear side, inserting an electrolyte on the rear side, and sealing the cavity by a cover layer.

According to another embodiment of the present invention, there is provided a method for the production of an integrated hydride air accumulator system, comprising the steps of: providing a substrate having a top side and a rear side, creating a diffusion barrier on the substrate, attaching and structuring an air electrode on the top side of the substrate, creating a cavity on the rear side of the substrate up to the air electrode, operatively creating an ionically conductive member on a rear side of the air electrode, precipitating a hydride storage device on a rear side of the membrane, providing a counter electrode on the rear side of the hydride storage device, providing an electrolyte on the rear side proximate the hydride storage device, and sealing the cavity with a cover layer.

An integrated hydride/air accumulator in accordance with the invention has an air electrode, a hydride storage device, as well as a counter electrode that is conductively connected to the hydride storage device. At least the hydride storage device is in contact with an electrolyte. In order to facilitate the reaction between the electrolyte with the air electrode and ambient oxygen in the air, an ionically conductive membrane is arranged between the air electrode and the counter electrode.

In the following, the side of the air electrode is also denoted as the front side, and the side opposite of the air electrode as the rear side of the integrated hydride/air accumulator. The terms ‘frontal’ and ‘rear’ are used, respectively.

Such design has the advantage that the air electrode is separated from the rest of the arrangement by the ionically conductive membrane. The ionically conductive membrane, such as an ionically conductive polymer electrolyte membrane, facilitates on the one hand the ionic conduction that is necessary for the reaction, but on the other is impermeable for metal cations. Metal cations such as would be present in the inorganic alkali solutions used as the electrolyte would react at the air electrode with the ambient carbon dioxide to form carbonates, which would therefore damage the air electrode.

The ionically conductive membrane moreover facilitates the use of economical hydrides and catalysts and at the same time has the advantage that any water created on the side of the hydride storage device is released. As a result, the “drowning” of the air electrode that can happen with normal PEM fuel cells, is completely prevented.

An economic AB₅ low-pressure metal hydride can be used for the hydride storage device, for example, which can be processed without having a special protective atmosphere and which can also be used in significantly thicker layers, such as is feasible for lithium in accumulators, for example. By using greater layer thicknesses for the hydride it is possible to achieve a higher surface-related energy storage density. In addition, palladium, ceramic composites, or nano materials, such as nano tubes made of carbon can be used, for example.

With such arrangement it is particularly advantageous, if the front of the air electrode is directly arranged on the ionically conductive membrane. This arrangement has the advantage of a particularly compact design and a directly conductive connection between the air electrode and the ionically conductive membrane and thus with the electrolyte.

In a further development of the accumulator, the counter electrode and/or the hydride storage device is comprised of a metal hydride, such as a low-pressure metal hydride. In addition to an electrical contact, the counter electrode thus forms at the same time an additional hydride for the storage of hydrogen and a reaction in the accumulator.

On the rear of the accumulator, i.e. on the side that is opposite the air electrode, it can be sealed by a cover layer, such as a ceramic one or a polymer, or by a Teflon membrane, for example. Alternatively, the cover layer can also consist of a metal or glass. A gas-permeable cover layer is preferred, so that any reaction gases that are created can escape. This cover layer on the rear will also prevent the evaporation of the electrolyte, and in addition, an electrolyte reservoir can be formed, for example. An electrolyte reservoir has the advantage that an increased amount of electrolyte can be provided by it, so that the capacity of the accumulator is only limited by the size of the metal hydride storage device and not by the quantity of the electrolyte present. Advantageously, excess electrolyte will be present.

Using a porous hydride for designing the hydride storage device, a large reaction surface between the hydride and the electrolyte is achieved and the electrolyte can get through the porous material right up to the bottom side of the ionically conductive membrane. Moreover it is possible to achieve increased hydrogen storage in the hydride storage device.

In the development of the hydride/air accumulator in accordance with the invention, a photocatalytic semiconductor layer is arranged on the rear of the hydride storage device and/or the counter electrode. As a result of the photocatalytic semiconductor layer, it is possible to achieve self-charging of the accumulator with sufficient energy through incident light radiation. For this purpose it will be an advantage if the cover layer on the rear consists of a material that is transparent at least for certain wavelengths.

The photocatalytic semiconductor layer may, for example, consist of titanium oxide (TiO₂) or of strontium titanate (SrTiO₃). Under solar irradiation, oxygen will be generated photocatalytically at the semiconductor/electrolyte boundary layer and hydrogen at the hydride electrolyte boundary layer that will then be stored in the hydride. Thus, in principle, the accumulator can function as an autonomous system, i.e. simultaneously as generator and energy storage device.

In terms of manufacturing engineering, it will be advantageous if the hydride/air accumulator is integrated into a carrier material designed as a frame which, for example, may be a silicon wafer or a correspondingly structured frame, e.g. one made of steel. Such a frame will provide the necessary stability for the structure of the accumulator and, due to the fact that the accumulator is processed into the frame and not onto a carrier material, makes it possible for the top side as well as the underside of the accumulator to be chemically active.

Such a frame is equipped, particularly if additional integrated circuits are provided, with a diffusion barrier for the ions from the electrolytes and thereby prevents damages to adjacent structural elements. Moreover, the same or additional diffusion barrier layers may serve as diffusion suppression of the stored hydrogen, thereby suppressing an auto discharge of the accumulator.

The fundamental functionality of an integrated metal hydride/air accumulator in accordance with the invention can be described as follows:

During a charging process, the electrolyte is oxidized to oxygen at the air electrode, with a reduction reaction of the air oxygen being made possible during the discharging process. At the counter electrode, the electrolyte is reduced to hydrogen and stored and the stored hydrogen is again oxidized during the discharging process. Electrical current and water are generated. The functionality of a hydride/air accumulator described above can be described by means of the following reaction equations:

### Charging:

Cathode:

n OH⁻+n h⁺→n/4 O₂+n/2 H₂O

Anode:

### Discharging:

Cathode:

n/4 O₂+n/2 H₂O+n e⁻→n OH⁻

Anode:

MHₙ+n OH⁻→M+n H₂O+n e⁻

Photo charging:

Anode:

hv→e⁻+h⁺

In this context, M denotes the electrically conductive component used for the hydride, otherwise, the customary nomenclature is being used.

For the photo charging process, an electron is released from the semiconductor formation through an incident photon and migrates off in the direction of the hydride due to the band bending, thereby triggering the reaction for the charging process described in the case of the anode. In the oxidation reaction described for the cathode, the hole that is likewise created reacts during the charging process with the electrolyte, thereby generating oxygen and water.

The method in accordance with the invention for the production of an integrated hydride/air accumulator on a carrier provides that, in a first step, a diffiision barrier is generated on the surface of the substrate. Subsequently, the air electrode is attached and structured onto the top side of the substrate and a cavity extending to the underside of the air electrode is installed in the substrate from the rear. As the fourth step, an ionically conductive membrane is attached directly onto the air electrode from the rear. Subsequently, a hydride storage device is deposited, likewise from the rear, on the ionically conductive membrane onto which then a counter electrode will be installed. Finally, an electrolyte is installed in the cavity and the cavity is sealed on the rear side by a cover layer.

For the execution of this method, techniques used in thick film technology, thin film technology or microtechnology as well as in microelectronics may be used as will be recognized by those of skill in the art following study of the enclosed inventive disclosure.

Such a method has the advantage that it can be integrated into a CMOS [complementary metal oxide semiconductor] process without any problems which makes it excellently suited for an integration with additional circuiting elements as well as MEMS [micro-electromechanical systems]. The process is preferably carried out in the sequence indicated above, but it may also have variations in the course of the process, in particular in the sequence of the process steps. Moreover, the process described above for the production of an integrated hydride/air accumulator has the advantage that it can be carried out through standard CMOS processes in the low temperature range, thereby exerting only a minor stress on a preset temperature budget. Therefore, the accumulator can be manufactured without any further ado as a backend process using standardized clean room processes.

To avoid any wet etching processes, the air electrode can be structured in a lift-off process in which the electrode material can be applied, for example, through a PVD (physical vapor deposition) process, for example through vaporization or sputtering.

Also, in order to avoid any wet etching process, the cavity to be opened from the rear side can be created through a plasma etching process, for example RIE (reactive ion etching) or ICP (inductive coupled plasma) etching. Such plasma etching processes are very directed and therefore create vertical lateral walls in the substrate which brings along stability advantages. Alternatively, however, the cavity can be created through wet etching; in this context, one may fall back on a anisotrope KOH etching agent which will create a sloped lateral wall in the 111 direction of a silicon wafer and which therefore has advantages in the covering of edges for the electrical contacting of the hydride storage device. Also, on a sloping lateral wall, an additional layer of silicon nitrite (Si₃N₄) can be deposited which will protect the lateral walls from being cauterized by the electrolyte and which serves as an additional diffusion barrier. Silicon nitrite (Si₃N₄) can be used as masking layer for the plasma etching processes as well as for the wet etching processes.

The ionically conductive membrane and/or the hydride storage device can be applied by means of a dispenser, thereby making it possible to obtain a good layer thickness distribution as well as a good proportioning of the amounts of the materials. Following the dispensing, the solvents in which the articles for the membrane and/or the hydride storage device are dissolved will evaporate and the applied layers will dry out. For some solvents, it will be advantageous if this process is accelerated by a brief temperature step on a heating platter. However, during the depositing of the membrane it will make sense to slow down the evaporation of the solvent by reducing the ambient temperature to achieve a uniform layer thickness.

Following the depositing of the hydride storage device or following the attachment of the counter electrode, a photocatalytic semiconductor layer may be added to create the self-chargeability of the accumulator. Again, a possible depositing method may be selected from among the PVD methods. Preferably, the semiconductor layer will be sputtered on which will bring along the advantage of a somewhat greater penetration depth of the semiconductor layer into the underlying counterelectrode relative to the hydride storage device.

A non-limiting example of an embodiment of the invention will be explained in detail in the following, with references being made to the attached figures. Same reference symbols will always designate the same or, respectively, analog components. Those of skill in the respective arts, having studied the attached disclosure, will recognize that the proposed systems may be prepared by the proposed methods.

The above, and other objects, features and advantages of the present invention will become apparent from the following description read in conjunction with the accompanying drawings, in which like reference numerals designate the same elements.

### BRIEF DESCRIPTION OF THE DRAWINGS

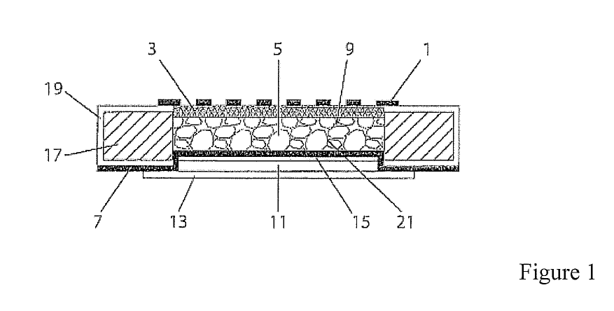

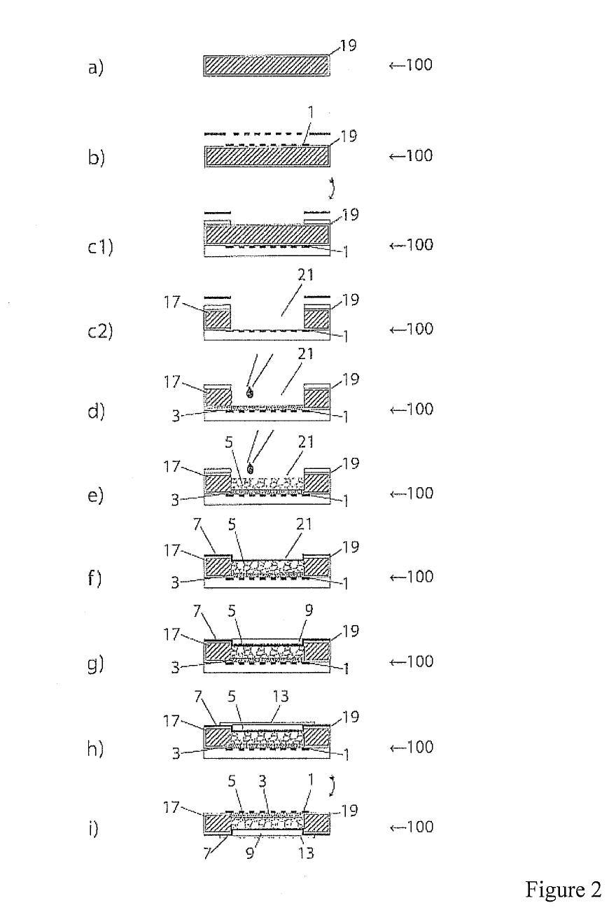

FIG. 1 is a cross section through an integrated hydride/air accumulator in accordance with one of the alternative embodiments of the present invention.

FIGS. 2A through 2I provide illustrative process steps in one of the proposed methods for manufacture of the hydride/air accumulator of FIG. 1.

### DETAILED DESCRIPTION OF THE PREFERRED EMBODIMENTS

Reference will now be made in detail to embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

Referring now to FIG. 1, a cross section through a hydride/air accumulator in accordance with the present invention is shown as processed into a frame 17 made of a silicon substrate 100. The frame 17 is equipped at its exterior boundary surfaces with a diffusion barrier 19 created prior to the manufacture of the accumulator through suitable process steps. The actual accumulator is a thin layer arrangement of an air electrode 1 arranged on the top side and arranged on an ionically conductive membrane 3, with the ionically conductive membrane 3 sealing on the top side a cavity 21 installed into the substrate 100. Preferably, an anionically conductive membrane will be used in this example. A hydride storage device 5 (or hydride storage means or system that serves to store energy in the form of hydrogen) is arranged in cavity 21 below ionically conductive membrane 3. Hydride storage device 5 is preferably formed by a metal hydride, for example an AB₅ low-pressure metal hydride. On the underside, the hydride storage device 5 is contacted in an electrically conductive fashion by a counterelectrode 7 that, for example, rimy be made of a metal hydride or nickel or other suitable substance according to the present invention.

The counterelectrode 7 serves to guide electrical contacts towards the exterior. A semiconductor layer 15 is applied on the underside of the counterelectrode 7 that may consist, for example, of titanium oxide or strontium titanate. Since the counterelectrode 7 as well as the semiconductor layer 15 are preferably applied by means of a sputtering process of low layer thickness, the semiconductor layer 15 will also simultaneously contact the hydride storage device 5. Since the counterelectrode 7 as well as the semiconductor layer 15, as seen from the underside, are still arranged within the cavity 21, a hollow space is sealed by a cover layer 13 arranged on the underside of the substrate that serves as electrolyte reservoir 11. A preferably liquid electrolyte 9 on the basis of an organic base is located in the electrolyte reservoir 11 as well as in the area of the porous hydride storage device 5. The electrolyte 9 is thus bounded laterally by the frame 17 as well as on the top side by the ionically conductive membrane 3 and on the underside by the cover layer 13 and thereby enclosed in the cavity 21.

In order to make a photocatalytic charging of the accumulator possible, the cover layer 13 is formed, for example, by a transparent Teflon® membrane.

Referring now further to FIGS. 2A through FIG. 2I which show an exemplary, non-limited process for the manufacture of the hydride/air accumulator from FIG. 1. Those of skill in the art will recognize that, having studied the present invention, the proposed system may assembled by other processes without departing from the scope and spirit of the present invention as discussed herein. It will be understood that FIGS. 2A through FIG. 2I represent illustrative steps in a process, and are discussed as such below.

In step FIG. 2A, a diffusion barrier is created, for example through the depositing of silicon nitrite.

In step FIG. 2B, the air electrode 1 is produced by means of a lift-off process. A lift-off process is distinguished by the fact that in a first partial step, a photoresist layer is applied and structured through exposure to light and development whereupon, in a second partial step, the metallization for the air electrode 1 is applied, for example through sputtering or evaporation deposition, and subsequently the structure for the air electrode 1 is generated through the removal of the remaining photoresist residues. However, the air electrode 1 could also be produced, for example, by means of a hard mask process in which, prior to the metal depositing, a corresponding shadow mask is placed on the substrate to be processed.

Prior to the processing of the cavity 21 by means of RIE or ICP, the top side of the substrate together with the already structured air electrode 1 is protected from external influences through a passivation layer, for example through a thick photoresist layer.

In step FIG. 2C1 and FIG. 2C2, for the creation of the cavity 21 in the substrate 100 is again subdivided into a masking step FIG. 2C1) as well as a processing step FIG. 2C2. In the masking step FIG. 2C1), the base area of the cavity 21 is preset through the application and structuring of a hard mask, for example one made of silicon nitrite (Si₃N₄) and subsequently, the cavity 21 is created by means of a plasma process, for example RIE or ICP. With the aid of the known parameters for the wafer thickness as well as the reactivity of the etching process, the duration of an etching period required to get from the rear side to the air electrode 1 applied in step FIG. 2B) can be determined quite well. Also, many RIE facilities are equipped with a device for a so-called end-point detection, i.e. for the recognition of a stop layer, in this case of the air electrode 1. IE and ICP are anisotrope etching processes, i.e. an excavation of the substrates in the marginal areas of the mask by means of a directed etching process is avoided; therefore, a course of the lateral walls of the cavity 21 as vertical as possible is achieved through such an etching process. Optionally, the lateral walls of the cavity 21 can be selectively equipped with additional layers, e.g. for passivation or as an additional diffusion barrier 19, for example made of silicon nitrite (not shown here).

In the subsequent step FIG. 2D, the ionically conductive polymer electrolyte membrane 3 is installed from the rear side in the cavity 21 and is thus directly deposited onto the air electrode 1. The installation of the ionically conductive membrane occurs by a dispenser, i.e. by a semiautomatic or automatic dispensing device by means of which the dispensed amount, i.e. knowing the base area of the cavity 21, also the layer thickness of the ionically conductive membrane 3, can be adjusted very well.

In step FIG. 2E, the hydride storage device 5 is installed in the cavity 21 of the substrate by means of an additional dispenser and also from the rear side. The suspensions entered into the cavity 21 by means of the dispensers are equipped with a solvent portion for the purpose of liquidation that evaporates following the dispensing step so that the created layers will harden by themselves.

In the subsequent step FIG. 2F, a metallization for the counter electrode 7 is deposited on the hydride storage device 5 as well as on parts of the frame 17, for example through sputtering. In this context, the counter electrode 7 may consist, as described above, of a metal layer or of a low pressure metal hydride. In this step, high edge conformity, i.e. good edge overlapping, is to be observed so that an electric contact of the metal hydride storage device 5 and the electrolyte 9 will be assured through the counter electrode 7.

In a subsequent, yet optional step, a semiconductor layer 15, for example made of titanium oxide (TiO₂) or strontium titanate (SrTiO₃), is deposited onto the counter electrode 7 in the area of the cavity 21. The depositing of the semiconductor layer 15 may, for example, occur through sputtering. Through the sputtering of the semiconductor layer 15 onto the thin counter electrode 7, the surface of the hydride storage device 5 is simultaneously covered with semiconductor material from the semiconductor layer 15 as well. This behavior is assured in particular through the great surface roughness of the low pressure metal hydride used for the hydride storage device 5.

In the subsequent process step FIG. 2G, the cavity 21 that at this point in time has already been sealed on the top side by the ionically conductive membrane 3 and been filled with the hydride storage device 5, the counter electrode 7 and, if necessary, the semiconductor layer 15, will now be filled up with a liquid electrolyte 9.

Following the filling of the electrolyte 9, in an additional process step FIG. 2H, the cavity 21 is sealed on the rear side with a cover layer 13, for example a Teflon® membrane.

In a final process step FIG. 2I, a front side passivation by means of which the front side had been protected during process steps c) through h) carried out from the rear side will be removed. An arrow notes the rotation of the body for convenience.

In general, the design of the accumulator is also suited for large-area productions together with other frame materials such as, for example, steel and even flexible foil materials. Assuming an integrated photo chargeability, accumulators can be produced in this manner that are suitable for the operation of larger autonomous devices.

### LIST OF REFERENCE SYMBOLS

1 air electrode

2 ionically conductive membrane

3 hydride storage

7 counter electrode

9 electrolyte

11 electro-reservoir

13 cover layer

15 semiconductor layer

17 frame

19 diffusion barrier

21 cavity

100 substrate

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

1-18. (canceled)

19. An integrated hydride air accumulator system, comprising:
an air electrode;
a hydride storage device;
a counter electrode;
an ionically conductive membrane arranged between said air electrode and said counter electrode;
said counter electrode conductively coupled with said hydride storage device; and
said hydride storage device being in operative contact with an electrolyte.

20. An integrated hydride air accumulator system, according to claim 19, wherein:
said air electrode is arranged on a front side directly on said ionically conductive membrane.

21. An integrated hydride air accumulator system, according to claim 20, wherein:
at least one of said counter electrode and said hydride storage device are formed of a metal hydride.

22. An integrated hydride air accumulator system, according to claim 21, wherein:
said metal hydride is a low-pressure metal hydride.

23. An integrated hydride air accumulator system, according to claim 19, wherein:
Said hydride storage device is formed from at least one of a metal hydride, a ceramic, an alloy, a polymer, a nanomaterial, or a combination thereof

24. An integrated hydride air accumulator system, according to claim 19, further comprising:
a cover layer on a rear side of said integrated hydride air accumulator system.

25. An integrated hydride air accumulator system, according to claim 19, further comprising:
an electrolyte reservoir proximate said cover layer.

26. An integrated hydride air accumulator system, according to claim 19, wherein:
said hydride storage device is formed of a porous hydride.

27. An integrated hydride air accumulator system, according to claim 19, further comprising:
a photocatalytic semiconductor layer
said photocatalytic semiconductor layer being arranged on a rear side of one of said hydride storage device and said counter electrode.

28. An integrated hydride air accumulator system, according to claim 24, wherein:
said cover layer consists of a material that is transparent within at least one wavelength range between ultraviolet and infrared radiation.

29. An integrated hydride air accumulator system, according to claim 19, wherein:
said hydride air accumulator system is integrated into a substrate designed as a frame, whereby said system is secured in an operative manner.

30. An integrated hydride air accumulator system, according to claim 29, further comprising:
a diffusion barrier is operatively provided on said frame for optimal performance of said system.

31. A method for the production of an integrated hydride air accumulator system, comprising the steps of:
providing a substrate;
creating a diffusion barrier on said substrate;
providing an air electrode;
attaching and structuring an air electrode on one top side of said substrate;
creating a cavity on a rear side of said substrate up to said air electrode;
performing at least one of a step of attaching and creating an ionically conductive membrane on a rear side of said air electrode;
precipitation of a hydride storage device on a rear side of said membrane;
performing at least one of a step of attaching and creating a counter electrode on said rear side;
inserting an electrolyte on said rear side, and
sealing said cavity by a cover layer.

32. A method, according to claim 31, wherein:
said step of providing an air electrode further comprises a step of:
creating said air electrode by a process involving a lift-off technique.

33. A method, according to claim 31, wherein:
said step of creating a cavity further comprises a step of:
at least one of a chemical and a physical etching process, whereby said cavity is created.

34. A method, according to claim 31, wherein:
said step of precipitating a hydride storage device, further comprises a step of:
applying said hydride storage device as a dispensing process.

35. A method, according to claim 31, wherein:
said step performing at least one of a step of attaching and creating an ionically conductive membrane on said rear side of said air electrode, further comprises a step of:
applying said membrane as a dispensing process.

36. A method, according to claim 31, further comprising the steps of:
applying a photocatalytic semiconductor layer.

37. A method for the production of an integrated hydride air accumulator system, comprising the steps of:
providing a substrate having a top side and a rear side;
creating a diffusion barrier on said substrate;
attaching and structuring an air electrode on said top side of said substrate;
creating a cavity on said rear side of said substrate up to said air electrode;
operatively creating an ionically conductive member on a rear side of said air electrode;
precipitating a hydride storage device on a rear side of said membrane;
providing a counter electrode on said rear side of said hydride storage device;
providing an electrolyte on said rear side proximate said hydride storage device; and
sealing said cavity with a cover layer.
